(19) United States
(12) Patent Application Publication
(10) Pub. No.: US 2025/0340029 A1
(43) Pub. Date: Nov. 6, 2025

(54) BLADDER ASSEMBLY STRUCTURE

(71) Applicant: HYUN JU SHIN, Daejeon (KR)

(72) Inventor: HYUN JU SHIN, Daejeon (KR)

(21) Appl. No.: 19/197,577

(22) Filed: May 2, 2025

(30) Foreign Application Priority Data
May 2, 2024 (KR) 10-2024-0058556

(51) Int. Cl. B29D 30/06

(52) U.S. Cl. CPC B29D 30/0654; B29D 30/0606; B29D 2030/0659

(57) ABSTRACT

According to the present invention, a bladder assembly structure for detachably attaching a bladder to a tire vulcanization apparatus is proved, wherein it comprises: a lower clamp for fixing a lower side bead of the bladder and allowing a housing to be coupled thereto; and an upper clamp for fixing an upper side bead of the bladder and allowing an upper end of a center post penetrating the housing to be coupled, wherein the upper and lower clamps are made of lightweighted aluminum material.

### CROSS-REFERENCE TO RELATED APPLICATION(S)

This application claims priority to and benefits of Korean Patent Application No. 10-2024-0058556 under 35 U.S.C. § 119, respectively filed on May 2, 2024, in the Korean Intellectual Property Office, the entire contents of which are incorporated herein by reference.

### BACKGROUND

### Field of the Invention

The present invention is related to a bladder assembly structure, and more particularly to the bladder assembly structure included in a vulcanization apparatus for use in a vulcanization process for a tire, wherein the materials for upper and lower clamp rings for respectively securing upper and lower beads are lightened in their weight, and wherein workability may be improved through increase in durability by way of changes in structure.

### Background of the Related Art

Generally, a tire vulcanizing apparatus is the means for causing combination between rubber molecules by a method of pressurizing and heating a green tire, which is molded by combining carcass and steal belts, beads, treads and etc., to thereby reduce plasticity or increase elasticity or tensile strength in a wide range of temperature, so that various functions of the tire may be achieved

Such vulcanization or compression apparatus may be called as a vulcanizer or a vulcanization apparatus, and a tire may be called as a green tire, before such compression, heating and etc. are performed.

As shown in FIGS. 1-3, the conventional vulcanizer for a tire comprises: a bladder assembly structure 40, wherein a lower bead 11 of a bladder 10 is fixed through a lower clamp 20 and an upper bead 12 of the bladder 10 is fixed through an upper clamp 30; a housing 50 coupled to the lower clamp 20; and a center post 60 which enables to move upward and downward within the housing 50 and which is coupled to the upper clamp 30 to thereby allow the bladder assembly 40 to mov upward and downward.

Herein, the lower clamp 20 has a lower clamp ring 21 on which an upper face of the lower bead 11 of the bladder 10 is supported, and a lower bead ring 22 on which a lower surface of the lower bead 11 of the bladder 10 is supported and which allows the lower bead 11 of the bladder 10 to be secured thereto by screw-coupling to the lower clamp ring 21, wherein a housing 50 is coupled to an inner periphery of a housing coupling container 21a, which has a predetermined thickness and a cylindrical shape and which extends through a center of the lower clamp ring 21.

Also, the upper clamp 30 has an upper clamp ring 31 on which a lower face of the upper bead 12 of the bladder 10 is supported, and an upper bead ring 32 on which an upper face of the upper bead 12 of the bladder 10 is supported and which allows the upper bead 12 of the bladder 10 to be coupled by screwing to an upper clamp ring 31, wherein an upper end of a center post 60 is coupled to an inner periphery of a post coupling container 31a which extends through a center of the upper clamp ring 31 with a predetermined thickness and a cylindrical shape.

However, the conventional lower clamp 20 and the convention upper clamp 30 are made of steel material in order to let the lower clamp ring 21 and the upper clamp ring 31 sustain a high temperature and a high pressure. Thus, the lower and upper clamps 20 and 30 cannot but choose to have a heavy weight. Accordingly, an operator has a large workload to replace the lower clamp ring 21 and the upper clamp ring 31, when performing replacement due to wear of the bladder 10, so that it leads to degradation in replacement work.

Also, the conventional lower clamp 20 and upper clamp 30 are forcefully and repetitively adhered to a lower mold or an upper mold, respectively, while moving up and down through the center post 60 in the vulcanization process, since a housing coupling container 21a of the lower clamp ring 21 to which the housing 50 is coupled, and a post coupling container 31a of the upper clamp ring 31 to which the center post 60 is coupled, simply have a predetermined thickness and a cylindrical body shape. Here, since media with the higher temperature and the higher pressure are injected into and exhausted from the inner side of the bladder 10, a housing coupling container 21a and a post coupling container 31a may be easily deformed in their shape or may have cracks therein. Accordingly, there are problems in that the conditions for vulcanizing cannot be maintained and in that the vulcanizing quality of the green tire may be degraded.

### Prior Art Documents

(Patent Document 0001) Registered Patent 10-0164022

(Patent Document 0002) Registered Patent 10-2121377

(Patent Document 0003) Registered Patent 10-1601664

(Patent Document 0004) Registered Patent 10-0552019

### SUMMARY

### Object of the Invention

Thus, the object of the present invention is to provide the bladder assembly structure that can improve the workability through the improvement in durability by way of lightening material of an upper clamp ring and a lower clamp ring for respectively fixing an upper bead and a lower bead of the bladder in the bladder assembly structure, which is provided in the vulcanization apparatus for used in the vulcanizing process of a tire, and the modification of their structure

Meanwhile, the object of the present invention shall not be limited to the above-described ones, and other objects that are not mentioned herein will be apparent to one of ordinary skill in the art in view of the description below.

### SUMMARY OF THE INVENTION

According to the present invention, a bladder assembly structure for detachably attaching a bladder to a tire vulcanization apparatus is provided, which comprises: a lower clamp, which fixes a lower side bead of the bladder and to which a housing is coupled; and an upper clamp, which fixes an upper side bead of the bladder and to which an upper end of a center post penetrating the housing is secured, wherein the lower and upper clamps are made of lightweight aluminum material.

Here, the lower clamp comprises: a lower clamp ring, on which an upper surface of the lower side bead of the bladder is supported and to which the housing is coupled; a lower bead ring, which allows the lower bead of the bladder to be coupled by means of a lower surface of the lower side bead of the bladder being supported and coupled to a lower clamp ring. The lower clamp ring includes aluminum material, and preferably comprises: a lower clamp panel in the shape of a circular plate; a lower side bead groove, which is formed as a concave groove structure at an edge part of the lower surface of the lower clamp panel and which allows an upper surface of the lower side bead of the bladder to be fitted thereto; a ring for coupling a lower bead ring, which allows the lower bead ring to be screwed thereto, which is configured to protrude with the diameter smaller than that of the lower side bead groove from a lower surface of a lower clamp panel formed with the lower side bead groove, and which allows a lower surface of the lower side bead of the bladder to be fitted through a plurality of lower coupling holes; a housing coupling container, which is configured for communication from an upper surface of the lower clamp panel toward a lower surface thereof with a predetermined thickness and a predetermined length, and which allows a housing to be coupled to an inner peripheral surface; and, a lower reinforcement part, which is formed for reinforcement from an inner peripheral surface of the ring for coupling the lower bead ring to a middle part of a housing coupling container, to thereby increase stiffness of the housing coupling container.

Further, the upper clamp comprises: an upper clamp ring on which a lower surface of the upper side bead of the bladder is supported and to which an upper end of the center post is coupled; and, an upper bead ring, which enables an upper side bead of the bladder to be coupled by an upper surface of the upper side bead of the bladder being supported and being coupled to the upper clamp ring, wherein the upper clamp ring is made of aluminum material, and it preferably comprises: an upper clamp panel in the shape of a circular plate; an upper side bead groove, which is formed as a concave groove structure in an edge area of the upper surface of the upper clamp panel and which allows a lower surface of the upper side bead of the bladder to be fitted; a ring for coupling an upper bead ring, which is configured to protrude with the diameter smaller than that of an upper side bead groove on an upper surface of an upper clamp panel formed with an upper side bead grove, and to which an upper bead ring is screwed, wherein the upper bead ring allows an upper surface of the upper side bead of the bladder to be fitted through a plurality of upper coupling holes; a post coupling container, which is configured for communication from a lower surface of the upper clamp panel to an upper surface with a predetermined thickness and a predetermined length, and an inner peripheral surface of which an upper end of the center post is coupled thereto; and an upper reinforcement part, which is formed from an inner peripheral surface of the ring for coupling the upper bead ring to an upper end part of the post coupling container for reinforcement, to thereby increase stiffness of the post coupling container.

### Effect of the Invention

Thus, according to the present invention, it may be possible to improve the workability through the improvement in the durability, by changes in the structure and lightening of materials for the upper and lower clamp rings for respectively fixing the upper and lower beads of the bladder, which are provided in the bladder assembly structure configured in the vulcanization apparatus used in the tire vulcanization process.

On the other hand, the effects of the present invention are not limited to the ones mentioned above, and other effects which are not mentioned above will be apparently understood by one of ordinary skill in the art in view of the recitations in the claims.

### BRIEF DESCRIPTION OF THE DRAWINGS

FIG. 1 is a perspective view showing a bladder assembly structure of the prior art;

FIGS. 2 and 3 respectively shows lower and upper clamp rings in the bladder assembly structure shown in FIG. 1;

FIG. 4 is a cross-sectional view showing the bladder assembly structure in accordance with a preferred embodiment of the present invention;

FIGS. 5 and 6 are perspective views of the lower and upper clamp rings provided in the bladder assembly structure shown in FIG. 4;

FIGS. 7 and 8 are side cross-sectional views respectively showing the lower and upper clamp rings in FIGS. 5 and 6; and,

FIGS. 9 and 10 are bottom and planar views, respectively, showing the upper and lower clamp rings in FIGS. 4 and 5.

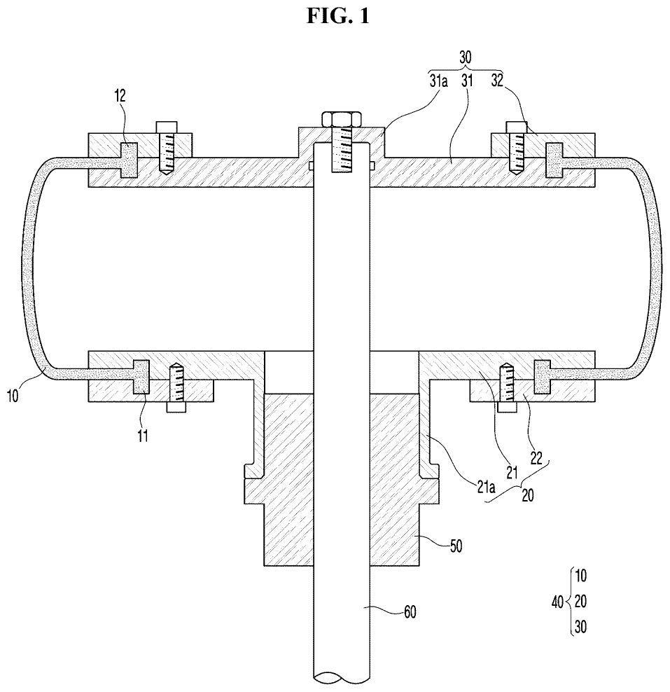

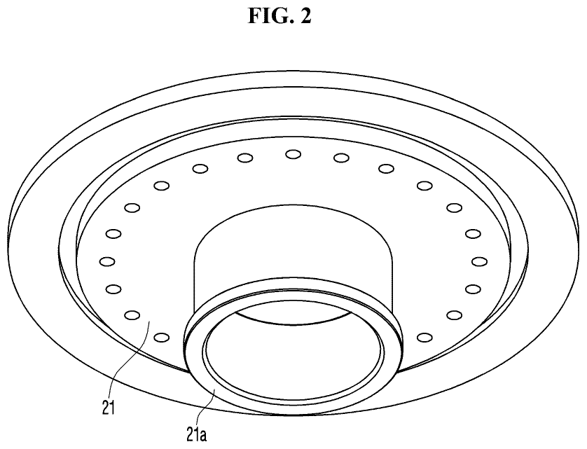

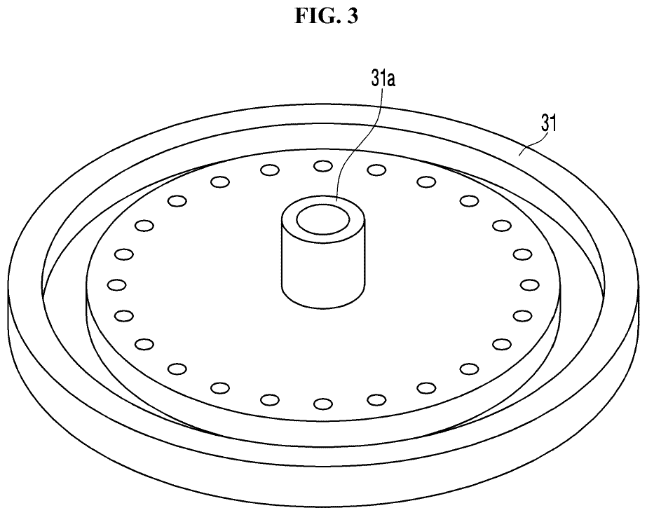

### DETAILED DESCRIPTION OF THE INVENTION

Herein-below, the preferred embodiments of the present invention will be specifically described with reference to the drawings accompanied.

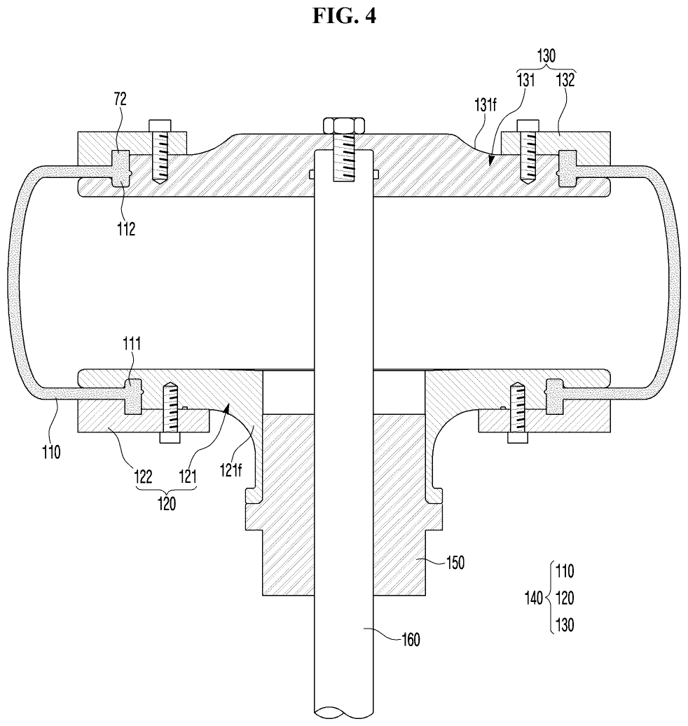

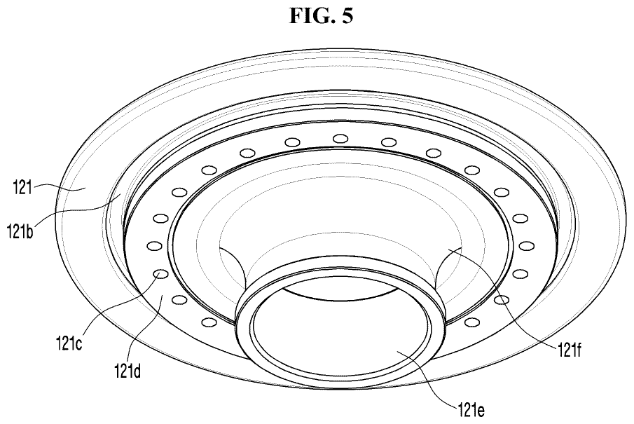

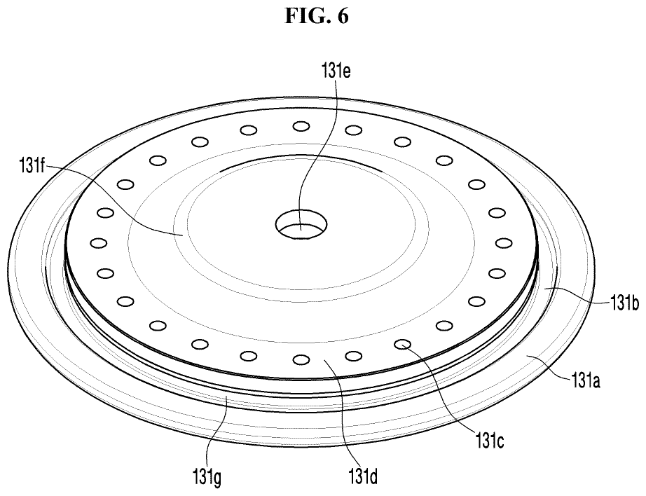

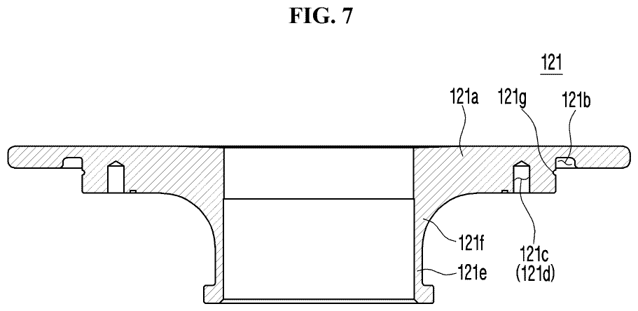

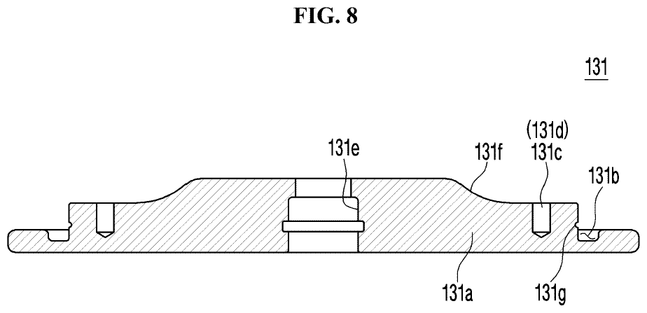

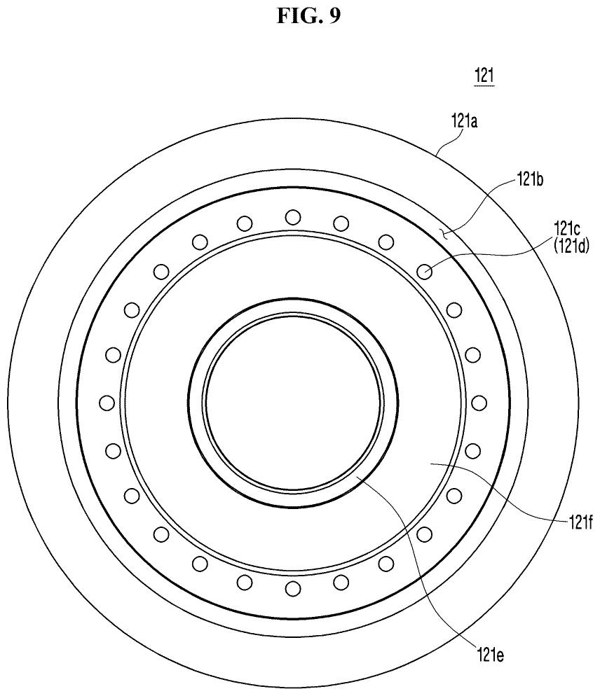

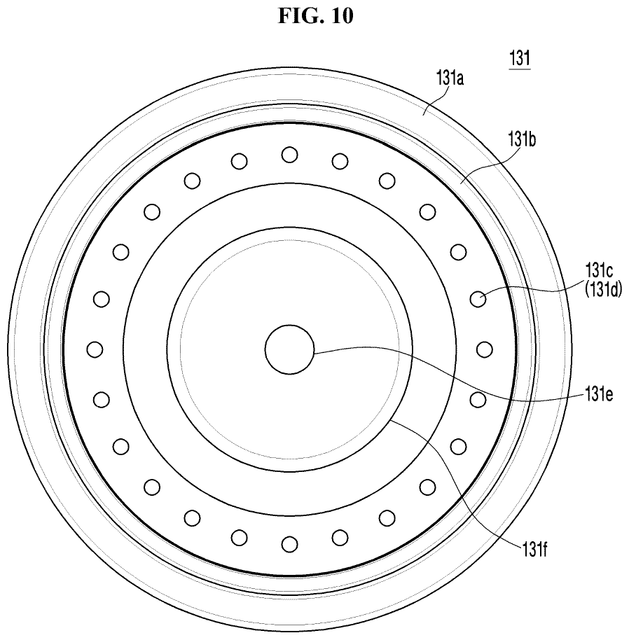

As shown in FIGS. 4-10, the bladder assembly structure 140 in accordance with the preferred embodiment of the present invention is configured to detachably mount a bladder 110 to the tire vulcanization apparatus, comprising; a lower clamp 120, which clamps a lower bead 111 of the bladder and to which a housing 150 is coupled; and an upper clamp 130, which clamps an upper bead 112 and to which an upper end of a center post 160 penetrating the housing 150 is coupled. Here, the lower clamp 120 and the upper clamp 130 are made of lightweighted aluminum material.

Here, the tire vulcanization apparatus operates in such a way of loading a green tire between the upper clamp 130 to which an upper end of the center post 160 is coupled and the lower clamp 120 to which the housing 150 is coupled, raising the center post 160 to thereby pressurize and close the upper clamp 130 and the lower clamp 120, respectively, against upper and lower molds. In such a state, the bladder 110 is allowed to expand within an interior of the green tire, to thereby allow the green tire to press and heat the upper and lower molds, respectively. Accordingly, tread patterns are formed on the green tire, and at the same time, rubber and sulfur on the green tire reacts with each other, to thereby let the vulcanization process proceed, wherein bonding is achieved between the molecules.

The bladder 110 is the means for pressing the green tire against the mold side, wherein the lower bead 111 and the upper bead 112 are fixed by means of the lower clamp 120 and the upper clamp 130, respectively and wherein it expands when media with the higher temperature and the higher pressure are supplied from the gas supply and exhaustion means, whereas it retracts when the gas exhaustion is performed. More detailed description with respect thereto will be omitted, since it may have the well-known structure.

The lower clamp 120 is the means for fixing the lower bead 111 of the bladder 110 and for allowing the housing 150 to be coupled thereto, comprising: a lower clamp ring 121 on which an upper surface of the lower bead 111 of the bladder 110 is supported and to which a housing 150 is coupled; and a lower bead ring 122 on which a lower surface of the lower bead 111 of the bladder 110 is supported and which makes the lower bead 111 of the bladder 110 to be coupled thereto via screwing to the lower clamp ring 121.

The lower clamp ring 121 includes: a lower clamp panel 121a, which includes aluminum material and which is in the shape of a circular plate with a predetermined thickness and a predetermined area; a lower bead groove 121b, which is formed to have a concave groove structure with a ring shape in an area of a lower surface edge of the lower clamp panel 121a and which lets an upper surface of the lower bead 111 of the bladder 110 fit thereto; a coupling ring 121d of a lower bead ring, which is configured to protrude with a predetermined thickness, while having a ring shape with its diameter smaller than that of a lower bead groove 121b on a lower surface of a lower clamp panel 121a formed with the lower side bead groove 121b, and which allows a lower bead ring 122 for fitting a lower surface of a lower side bead 111 of the bladder 110 through a plurality of lower coupling holes 121c to be screwed thereto; a housing coupling container 121e, which is configured to communicate from an upper surface of a lower clamp panel 121a to its lower surface, with a predetermined thickness and a predetermined length, and which has a housing 150 to be coupled to an inner peripheral surface; and, a lower reinforcement part 121f, which is formed for reinforcement from an inner peripheral surface of the coupling ring 121d for the lower bead ring to a lower bead ring to a middle part of the housing coupling container 121e with a predetermined curvature, to thereby allow an outer circumferential surface of the housing coupling container 121e to be tapered from a lower surface of the lower clamp panel 121a, so that any impact exerted on the housing coupling container 121e may be dispersed or absorbed to thereby increase strength of the housing coupling container 121e.

Here, the lower clamp ring 121 allows whole weight of the lower clamp 120 to be lightened since it is made of aluminum material. Accordingly, an operator's endeavor is not added at the time of replacing the bladder 10, so that the workability in replacement of the bladder 10 may be improved therethrough.

Also, the lower reinforcement part 121f has the curvature radius R40 from an inner peripheral surface of the ring 121d for coupling the lower bead ring of the lower clamp panel 121a to a middle part of the housing coupling container 121e, when the lower clamp panel 121a has a diameter of 460 mm and the housing coupling container 121e has a diameter of 141 mm. If any curvature is greater than the above, the thickness of the lower reinforcement part 121f becomes thicker than that of the lower clamp panel 121a and stiffness increases too much, so that the stress generated in the housing coupling container 121e is concentrated to the lower clamp panel 121a as it is, to thereby deform the lower clamp panel 121a or cause damages thereto. If any curvature is smaller than the above, the thickness of the lower reinforcement part 121f cannot be secured sufficiently, so that it may be impossible to disperse the stress generated in the housing coupling container 121e to a connecting area between the lower clamp panel 121a and the housing coupling container 121e, to thereby deform the housing coupling container 121e or cause damages thereto. Thus, it is preferable that the above-defined curvature is employed.

Meanwhile, a lower clamp ring 121 is formed with a lower band fitting groove 121g by the ring 121d for coupling the lower bead ring being protruded with a predetermined thickness, while having a ring shape with the dimeter smaller than that of a lower side bead groove 121b on a lower surface of a lower clamp panel 121a formed with the lower side bead groove 121b. A latching band (not shown) protruding from an inner periphery of the lower bead 111 of the bladder 110 is fitted to a boundary between a lower bead ring coupling ring 121d and a lower surface of the lower clamp panel 121a on a lower band fitting groove 121g, and thus, it may be possible to improve fixing force.

The lower bead ring 122 is made of aluminum material, and may have a well-known configuration, wherein a lower surface of the lower side bead 111 of the bladder 110 is supported and is screwed to the ring 121d for coupling the lower bead ring of the lower clamp ring 121, so that the lower side bead 111 of the bladder 110 is coupled. Accordingly, more detailed description will be omitted.

Accordingly, by means of the lower clamp 120, at least the lower clamp ring 121 is manufactured using aluminum material, so that the light weight may be ensured to thereby facilitate the replacement work of the bladder 110.

Also, the lower clamp ring 121 may be lightened in its weight with aluminum material by forming a lower reinforcement part 121f to have a predetermined curvature at a connection area between a housing coupling container 121e and a lower clamp ring 121, and thus, it may be possible to solve the problem that durability of the housing coupling container 121e is degraded, on which stress is repeatedly concentrated during the vulcanization process.

An upper clamp 130 is the means for fixing the upper side bead 112 of the bladder 110 and for allowing an upper end of the center post 160 to be coupled therewith, wherein it comprises: an upper clamp ring 131 on which a lower surface of the upper side bead 112 of the bladder 110 is supported and to which an upper end of the center post 160 is coupled, and an upper bead ring 132 on which an upper surface of the upper side bead 112 of the bladder 110 is supported and which allows the upper side bead 112 of the bladder 110 to be coupled by being screwed to the upper clamp ring 131.

The upper clamp ring 131 is made of aluminum material, and it comprises: an upper clamp panel 131a in the shape of a circular plate having a predetermined thickness and a predetermined area; an upper side bead groove 131b formed to have a concave groove structure, while having a ring shape in an edge area of an upper surface of the upper clamp panel 131a, to thereby allow a lower surface of the upper bead 112 of the bladder 110 to be fitted thereto; a ring 131d for coupling an upper bead ring, which is configured to have a ring shape with the diameter smaller than that of an upper side bead groove 131b on an upper surface of the upper clamp panel 131a formed with the upper side bead groove 131b and to protrude with a predetermined thickness, and which allows an upper bid ring 131 to be screwed thereto, wherein the upper bid ring allows an upper surface of the upper side bead 112 of the bladder 110 to be fitted through a plurality of upper coupling holes 131c; a post coupling container 131e which is configured for communication with a predetermined thickness and a predetermined length from a lower surface of the upper clamp panel 131a to its upper surface and which has an upper end of the center post 150 coupled to an inner peripheral surface thereof; and, an upper reinforcement part 131f, which is formed for reinforcement to have a predetermined curvature from an inner peripheral surface of the ring 131d for coupling an upper bead ring to an upper end part of the post coupling container 131e, to thereby allow an outer peripheral surface of the post coupling container 131e to be tapered from an upper surface of the upper clamp panel 131a, so that any impact exerted on the post coupling container 131e will be dispersed or absorbed to thereby increase stiffness of the post coupling container 131e.

Here, the upper clamp ring 131 includes aluminum material to thereby allow the whole weight of the upper clamp 130 to be lightened. Thereby, it will not add worker's endeavor when replacing the bladder 110, and thus, it may be possible to improve the workability of replacement.

Also, the upper reinforcement part 131f may have the curvature of R50 from an inner peripheral surface of the ring 131d for coupling an upper bead ring of the upper clamp panel 131a to the upper end of the post coupling container 131e, when the upper clamp panel 131a has the diameter of 434 mm and the post coupling container 131e has the diameter of 38 mm. If the curvature is greater than the above, the thickness of the upper reinforcement part 131f becomes thiker than that of the upper clamp panel 131a, and the stiffness increases too much, so that the stress occurred in the post coupling container 131e may be concentrated on the upper clamp panel 131a as a whole, to thereby deform the upper clamp panel 131a or cause damage. If the curvature is smaller than the above, the stress occurred in the post coupling container 131e cannot be dispersed toward a connecting area between the upper clamp panel 131a and the post coupling container 131e, so that the post coupling container 131e will be deformed or cause damage, since the thickenss of the upper reinforcement part 131f is not sufficiently established. Accordingly, it is preferred to have the curvature as defined above.

Meanwhile, the upper clamp ring 131 is formed with an upper band fitting groove 131g in such a way that an upper bead ring coupling ring 131d protrudes with a predetermined thickness, while having a ring shape with the diameter smaller than that of an upper side bead groove 131b on an upper surface of an upper clamp panel 131a formed with an upper side bead groove 131b. A latching band (not shown) protruding from an inner periphery of the upper side bead 112 of the bladder 110 between upper boundaries of the upper bead ring coupling ring 131d and the upper clamp panel 131a is fitted to the upper band fitting groove 131g, so that it may be possible to improve force for fixation.

The upper bead ring 132 is made of aluminum material, and includes the well-known configuration, wherein the upper side bead 112 of the bladder 110 is coupled by means of the upper surface of the upper side bead 112 of the bladder 110 being supported and being screwed to the ring 131d for coupling the upper bead ring of the upper clamp ring 131. Accordingly, the detailed description with respect thereto will be omitted.

Accordingly, in connection with the upper clamp 130, at least the upper clamp ring 131 is manufactured with aluminum material, to thereby make it possible to ensure light weight and to facilitate the operation of replacing the bladder 110.

Also, the upper reinforcement part 131f at the connection area between the post coupling container 131e and the upper clamp ring 131 is formed with a predetermined curvature. Thereby, the upper clamp ring 131 may be lightened by way of using aluminum material to thereby enable to be lightened, and thus, it may solve the problem that the stress is repeatedly concentrated while in the vulcanization process, to thereby degrade durability of the post coupling container 131e.

Herein below, the bladder assembly structure in accordance with the preferred embodiment of the present invention will be described with respect to operation thereof as follows.

First of all, the lower bead ring 122 is screwed to the ring 121d for coupling the lower bead ring of the lower clamp ring 121, while in a state that an upper surface of the lower side bead 111 of the bladder 110 is fitted to a lower side bead groove 121b of the lower clamp ring 121 of the lower claim 120, and a lower surface of the lower side bead 111 of the bladder 110 is fitted to a corresponding part of the lower bead ring 122.

Thereafter, an upper bead ring 132 is screwed to the ring 131d for coupling the upper bead ring of the upper clamp ring 131, while being in a state that a lower surface of the upper side bead 112 of the bladder 110 is fitted to the upper side bead groove 131b of the upper clamp ring 131 of the upper clamp 130 and an upper surface of the upper bead 112 of the bladder 110 is fitted to a corresponding area of the upper bead ring 132.

Thereafter, the housing 150 is coupled to the housing coupling container 121e of the lower clamp ring 121 of the lower clamp 120, and an upper end part of the center post 160 penetrating the housing 150 is coupled to the post coupling container 131e of the upper clamp ring 131 of the upper clamp 130.

Here, the center post 160 is provided with means for supplying and discharging media with high temperature and high pressure within interior of the bladder 110, by means of the well-known manner.

Thereafter, the green tire is loaded between the upper clamp 130 and the lower clamp 120, and then the upper clamp 130 and the lower clamp 120 are respectively pressed against the upper mold and the lower mold to close them, due to the upward operation of the center post 160. In such a state, media with the higher temperature and the higher pressure are provided to inside of the bladder 110, and the green tire is compressed and heated to the upper and lower molds, respectively. Then, the tread patterns are molded on the green tire. At the same time, the vulcanization process proceeds, wherein rubber and sulphur of the green tire react with each other to thereby attain bonds between molecules.

Accordingly, as described above, it may be possible to let the whole weight of the bladder assembly structure be lightened by manufacturing the lower clamp 120 and the upper clamp 130 with aluminum material, and thus, it may be possible to facilitate replacement operation of the bladder 110.

Also, by means of the reinforcement part with a predetermined volume provided at outer peripheries of the housing coupling container 121e of the lower clamp 120 and the post coupling container 131e of the upper clamp 130, it may be possible to solve such problem as weakening durability of the housing coupling container 121 and the post coupling container 131e by stress, which is repeatedly concentrated during the vulcanization process, even though the lower clamp 120 and the upper clamp 130 are lightened due to aluminum material.

Herein above, although the preferred embodiments of the present invention have been described with reference to the drawings accompanied, but one of ordinary skill in the art may understand that it may be embodied in different specific configuration, since various replacements, modifications and changes thereto are possible within the scope that does not go beyond the technical idea or the essential characters of the present invention. Thus, it should be understood that the above-described embodiments are exemplary in every respect, but not limited thereto.

What is claimed is:

1. A bladder assembly structure for detachably mounting a bladder to a tire vulcanization apparatus, comprising:
a lower clamp, which fixes a lower side bead of the bladder and to which a housing is mounted; and
an upper clamp, which fixes an upper side bead of the bladder and to which an upper end of a center post passing through the housing is secured;
wherein the lower clamp comprises:
a lower clamp ring, on which an upper surface of the lower side bead of the bladder is supported and to which the housing is coupled; and, a lower bead ring, on which a lower surface of the lower side bead of the bladder is supported and which is coupled to the lower clamp ring to thereby allow the lower side bead of the bladder to be coupled thereto;
wherein the lower clamp ring is made of aluminum material and comprises:
a lower clamp panel in the shape of a circular plate;
a lower side bead groove, which is formed as a concave groove in an edge area of a lower surface of the lower clamp panel, to thereby allow an upper surface of the lower side bead of the bladder to be fitted thereto;
a ring for coupling a lower bead ring, which is formed to protrude with the diameter smaller than that of the lower side bead groove on a lower surface of the lower clamp panel formed with a lower side bead groove and to which a lower bead ring is screwed, wherein the lower bead ring allows a lower surface of the lower side bead of the bladder to be fitted through a plurality of lower coupling holes;
a housing coupling container, which is formed for communication from an upper surface of a lower clamp panel to a lower surface with a predetermined thickness and a predetermined length, and to an inner peripheral surface of which the housing is secured; and,
a lower reinforcement part which is formed for reinforcement from an inner peripheral surface of the ring for coupling a lower bead ring to a middle part of the housing coupling container, to thereby increase stiffness of the housing coupling container,
wherein the upper clamp comprises:
an upper clamp ring, on which a lower surface of the upper side bead of the bladder is supported and to which an upper end of the center post is coupled; and
an upper bead ring, which allows an upper side bead of the bladder to be coupled thereto, by means of an upper surface of the upper side bead of the bladder being supported and being coupled to the upper clamp ring; and
wherein the upper clamp ring is made of aluminum material and comprises:
an upper clamp panel in the shape of a circular plate;
an upper side bead groove, which is formed as a concave groove in an edge area of an upper surface of the upper clamp panel, and to which a lower surface of the upper side bead of the bladder is fitted;
a ring for coupling an upper bead ring, which protrudes with the diameter smaller than that of the upper bead groove on an upper surface of the upper clamp panel formed with an upper bead groove and, to which an upper bead ring is screwed, wherein the upper bead ring allows an upper surface of the upper side bead of the bladder to be fitted through a plurality of upper coupling holes;
a post coupling container, which is formed for communication from a lower surface of the upper clamp panel to an upper panel thereof with a predetermined thickness and a predetermined length, and which allows an upper end of the center post to be coupled to an inner peripheral surface thereof; and
an upper reinforcement part formed for reinforcement from an inner peripheral surface of the ring for coupling the upper bead ring to an upper end of a post coupling container, to thereby increase stiffness of a post coupling container.

2. The bladder assembly structure as claimed in claim 1,
wherein the lower reinforcement part has the curvature of R40 from an inner peripheral surface of the ring for coupling the lower bead ring of the lower clamp panel to a middle part of the housing coupling container, when the lower clamp panel has the diameter of 460 mm and the housing coupling container has the diameter of 141 mm.

3. The bladder assembly structure as claimed in claim 1,
wherein the upper reinforcement part has the curvature of R50 from an inner peripheral surface of the ring for coupling the upper bead ring of the upper clamp panel to an upper end part of the post coupling container, when the upper clamp panel has the diameter of 434 mm, and the post coupling container has the diameter of 38 mm.
